(19) United States
(12) Patent Application Publication
(10) Pub. No.: US 2014/0310169 A1
(43) Pub. Date: Oct. 16, 2014

(54) Secure electronic financial transaction method utilizing definite-use electronic bank accounts with random numbering system

(71) Applicant: Petr Kacena, Glencoe, IL (US)

(72) Inventor: Petr Kacena, Glencoe, IL (US)

(21) Appl. No.: 13/861,767

(22) Filed: Apr. 12, 2013

(51) Int. Cl. G06Q 20/10

(52) U.S. Cl. CPC G06Q 20/10
USPC 705/42

(57) ABSTRACT

The present invention describes techniques for facilitating secure electronic financial transactions between parties without sharing main bank account information or other sensitive financial data. The invention provides an innovative financial transaction method consisting of utilizing definite-use electronic bank accounts. Each definite-use electronic bank account is created for a specific transaction, specific obligation, and/or specific payment amount only. There is a parent-child relationship between a main bank account and definite-use electronic bank accounts. This is a hierarchical relationship, meaning that definite-use electronic bank accounts are created and funded using the main bank account. Each definite-use electronic bank account is assigned a random account number, which is retired upon the closure of the associated financial transaction. Furthermore, a breakthrough electronic payment guarantee method is introduced in conjunction with the application of definite-use electronic bank account method.

### CROSS-REFERENCE TO RELATED APPLICATIONS

None.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

Currently available payment processing methods have multiple limitations, such as limited fraud and credit loss protection, no ability to eliminate a need for exchanging sensitive banking information between buyers and sellers, and no ability to provide payment guarantees, to name a few.

Currently, the ACH credit transaction is one of the most utilized electronic payment methods. This is a buyer initiated transaction, where the buyer deposits the amount of payment due into the seller's account, using the ACH network. To initiate the ACH credit transaction, sellers must share their bank account details with buyers. This information is then used to transfer the ACH payment from the buyer's account to the seller's account.

The ACH credit transaction method has several key limitations:
Sellers are susceptible to the fraud risk because they must share their main bank account information with buyers.
Sellers are exposed to a data breach risk of their bank account information.
Sellers rely completely on buyers to hold sufficient funds in their accounts to be able to pay for delivered goods, and there are no inherent guarantees of buyers' accounts having sufficient funds.
Only limited remittance information is provided with ACH payments.

Another currently utilized electronic payment method is the ACH debit transaction. The ACH debit transaction is a seller initiated transaction, where the seller debits the buyer's account for the amount of payment due. To enable the ACH debit transaction, buyers must provide payment details to their vendors. The merchant (seller) then uses that information to “pull” the payment from the buyer's account.

The ACH debit transaction method has several key limitations:
Buyers are susceptible to the fraud risk because they must share their sensitive bank account information with sellers.
Buyers are exposed to a data breach risk of their bank data.
The process requires high level of trust between buyers and sellers.
Corporations and individuals are hesitant to allow another companies or individuals to “pull” money from their accounts.
The ACH debit system is not suitable for countries with less mature banking systems.
Sellers rely completely on buyers to hold sufficient funds in their accounts to be able to pay for delivered goods, and there are no inherent guarantees of buyers' accounts having sufficient funds.
Only limited remittance information is provided with payments.

The wire transfer is another electronic payment method currently used. The wire transfer is an electronic payment service developed and maintained by the Federal Reserve. It is a real-time gross settlement system that enables participants to initiate funds transfer that are immediate, final, and irrevocable once processed. The wire transfer is generally used for larger payments that are time critical. The wire transfer transaction method has the following key limitations:
Sellers are susceptible to the fraud risk because they must share their sensitive bank account information with buyers.
Sellers are exposed to a data breach risk of their sensitive bank data.
The process requires high level of trust between buyers and sellers.
Sellers rely completely on buyers to hold sufficient funds in their accounts to be able to pay for delivered goods, and there are no inherent guarantees of buyers' accounts having sufficient funds.
The U.S. wire transfer format standard is not compatible with emerging international standards.
The entire wire transfer process is a manual process, and a significant manual processing is required to reconcile wire transfer payments with invoice information.
No remittance information is provided with the wire payments.

The existing electronic payment solutions available for business to business financial transactions have numerous limitations. Thus, not surprisingly, the majority of payments between businesses are currently still done using checks. To achieve broad acceptance of electronic payments for transactions between businesses, improvements from both a buyer's and seller's perspective are desired. An innovative, state of the art electronic payment solution is desired. The solution should be designed to resolve the security and usability limitations, which are restraining the use of electronic payments.

The inventors have developed an innovative electronic payment system that eliminates the current security risks and limitations of currently used electronic payment methods.

### Field of the invention

This invention relates to electronic commerce. More particularly, this invention describes an innovative electronic payment method for conducting secure electronic payment transactions between buyers and sellers using a definite-use electronic bank account that is used for a specific transaction, specific payment amount only, and without exposure of their main bank account information or other sensitive financial data. Each definite-use electronic bank account is only created for a specific transaction, a specific obligation, and/or a specific payment amount, and it maintains a parent-child relationship with the customer's main bank account. Each definite-use electronic bank account is assigned a random account number, which is retired upon the closure of the payment transaction. Furthermore, a breakthrough electronic payment guarantee method is introduced in conjunction with the definite-use electronic bank account payment method.

### BRIEF SUMMARY OF THE INVENTION

This invention relates to electronic commerce. More particularly, this invention describes an innovative electronic payment method for conducting secure electronic payment transactions using definite-use electronic bank accounts.

Each definite-use electronic bank account is created for a specific transaction, definite obligation, and/or specific payment amount only. Each definite-use electronic bank account is assigned a random account number, which is retired upon the closure of the payment transaction. From external usage perspective the definite-use accounts are treated the same way as “normal” bank accounts, and as a result, the seller and/or buyer do not need to implement any new devices. Additionally, the use of definite-use electronic bank accounts does not require that it is implemented by both parties. It can be implemented and used by a seller, or a buyer, or by both seller and buyer.

The definite-use electronic bank account maintains a parent-child relationship with the customer's main bank account. This is a hierarchical relationship, meaning that the definite-use electronic bank accounts are created and funded using the main bank account. Upon the termination of the definite-use electronic bank account, all the remaining monies are deposited back to the main account. Only the account owner(s) or authorized person(s) can initiate the creation of the definite-use electronic bank accounts.

When the definite-use account information is used for the transaction between the buyer and seller, the main bank account information is not shared between the involved parties thus eliminating the risk of the main bank account information being misused, lost, or stolen.

Additionally, a breakthrough electronic payment guarantee feature called “electronic-Lock” (e-Lock hereafter) is introduced in conjunction with the definite-use electronic bank account method. The funds used with the definite-use electronic bank account are “good funds” because the money has to be available for the definite-use electronic bank account to be established. The e-Lock provides the electronic payment guarantee to the seller that the buyer has funds available, allocated, and locked in the definite-use electronic bank account in order to be able to pay for goods and services.

The definite-use electronic bank account method does not require buyers and sellers to exchange their sensitive main bank account information or other sensitive financial data. Furthermore, since the definite-use electronic bank accounts numbers are a transaction specific, they cannot be reused if stolen or mishandled. This inherent security significantly diminishes the likelihood of fraud and makes the system trustworthy, which means that buyers and sellers can confidently transfer payments without fearing that their main “parent” bank accounts could be misused.

### BRIEF DESCRIPTION OF THE DRAWINGS

FIG. 1 shows the electronic payment system during the initiation phase.

FIG. 2 shows the electronic payment system during the payment phase.

FIG. 3 shows the electronic payment system during the closure phase

### DETAILED DESCRIPTION OF THE INVENTION

The electronic payment utilizing the definite-use electronic bank account method consists of 3 steps:
1. Initiation Phase
2. Payment Phase
3. Closure Phase

During the initiation phase, a definite-use electronic bank account is established using a randomly generated account number. Only the account owner(s) or authorized person(s) can initiate the creation of definite-use electronic bank accounts. Each definite-use electronic bank account is established for a definite transaction, definite obligation, and/or definite payment amount only. The definite-use electronic bank account maintains parent-child relationship with the customer's main bank account. This is hierarchical relationship, meaning that the definite-use electronic bank accounts are created and funded using the main bank account. Upon the termination of the definite-use electronic bank account, all the remaining monies are deposited back to the main account. Additionally, any time after the definite-use bank account is established, the electronic-Lock (e-Lock hereafter) can be set up per buyer's request and authorization. The e-Lock feature provides an electronic payment guarantee to the seller that the buyer has sufficient funds available and allocated “locked” in the definite-use electronic bank account to pay for goods and services.

From external usage perspective definite-use accounts are treated the same way as “normal” bank accounts. As a result, sellers and/or buyers do not need to implement any new devices. Additionally, the use of definite-use electronic bank accounts does not require that it is implemented by both parties. It can be implemented and used by sellers, or buyers, or by both sellers and buyers.

During the payment phase, once the payment is authorized by the buyer, the funds are electronically transmitted from the buyer's definite-use electronic bank account to the seller's bank account, which could also be set up as a definite-use electronic bank account or could be just a “regular” bank account. In the case when only the seller is using the definite-use account method, the funds are electronically transmitted from the buyer's regular bank account to the seller's definite-use electronic bank account.

During the closure phase, for the buyer using the definite-use electronic bank account, the buyer's definite-use electronic bank account is closed; the account number is retired; and in case if there are any remaining monetary funds, those are moved back to buyer's main bank account. For the seller using the definite-use electronic bank account, the funds are automatically moved from the seller's definite-use electronic bank to the seller's main bank account, and then the seller's definite-use electronic bank account is closed, and the account number is retired.

### Initiation Phase

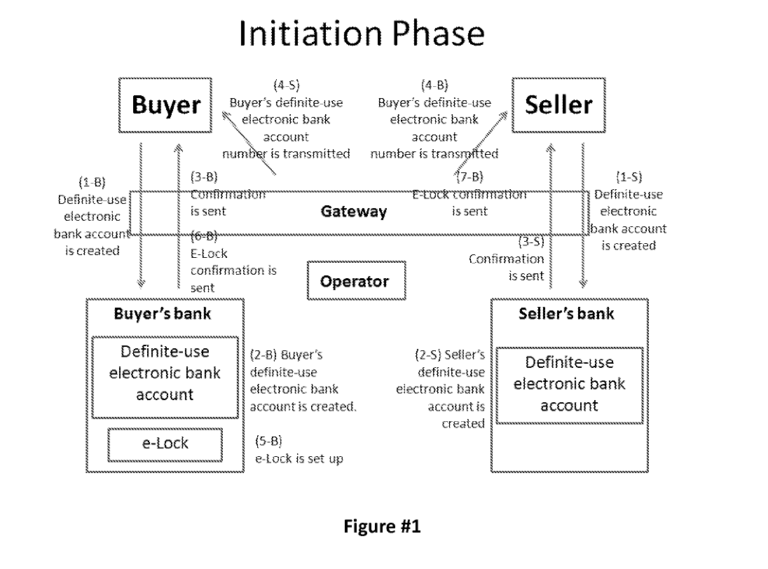

FIG. 1 shows the electronic payment system during the initiation phase. The FIG. 1 shows the initiation process flow from both buyers' and seller's perspective. As already noted, the definite-use electronic bank account method does not require that it is implemented by both parties. It can be implemented and used by sellers, or buyers, or by both sellers and buyers.

Definite-use electronic bank account initiation phase from a buyer's perspective:
1-B. The creation of a new definite-use electronic bank account starts when a buyer enters a new request to conduct a financial transaction. The definite-use electronic bank account is created for the specific transaction and specific amount.
2-B. The definite-use electronic bank account is established using a randomly generated account number, and requested funds are allocated to the definite-use electronic bank account from the buyer's main “parent” bank account. The definite-use electronic bank account maintains a parent-child relationship with the customer's main bank account. This is a hierarchical relationship, meaning that definite-use electronic bank accounts are created and funded using the main bank account.
3-B. A confirmation containing the definite-use electronic bank account number, creation date, balance, and other pertinent information is sent to the buyer.
4-B. If needed, the newly created buyer's definite-use electronic bank account number may be also communicated to the seller and/or seller's financial institution.
5-B. If requested and authorized by the buyer, then the electronic-Lock (e-Lock hereafter) is set up for the specific amount, specific transaction, and specific obligation.
6-B. A confirmation containing the e-Lock number, creation date, balance, and other pertinent information is sent to the buyer.
7-B. A confirmation containing the e-Lock number, creation date, balance, and other pertinent information is sent to the seller after the buyer's authorization is provided for sharing the e-Lock information with the seller.
   Definite-use electronic bank account initiation phase from a seller's perspective:
1-S. The creation of a new definite-use electronic bank account starts when a seller enters a new request to conduct a financial transaction.
2-S. The new seller's definite-use electronic bank account is established using a randomly generated account number, and linked to the seller's main “parent” bank account.
3-S. A confirmation containing the definite-use electronic bank account number, creation date, and other pertinent information is sent to the seller.
4-S. If needed, the newly created seller's definite-use electronic bank account number may be also communicated to the buyer and/or buyer's financial institution.

### Payment Phase

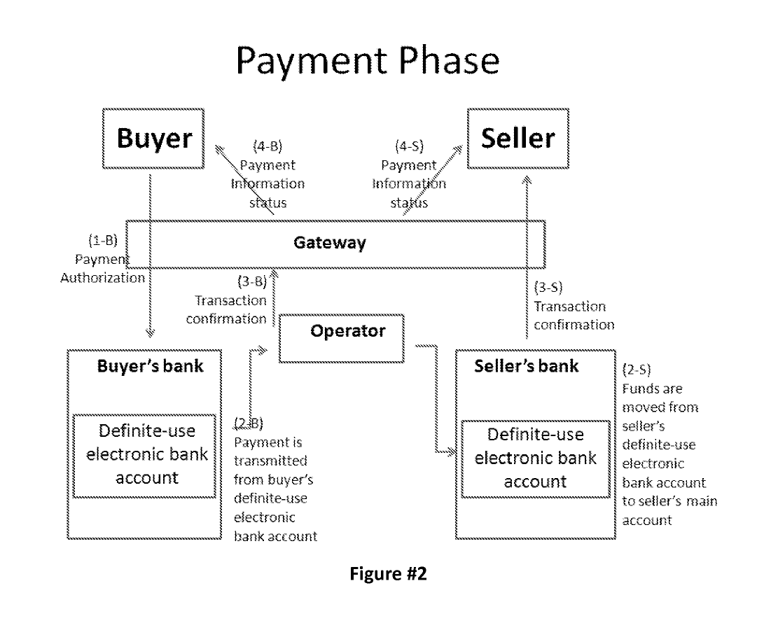

FIG. 2 shows the electronic payment system during the payment phase. The FIG. 2 shows the payment phase flow from both buyers' and seller's perspective; however, as already noted, the “definite-use electronic bank account” method does not require that it is implemented by both parties. It can be implemented and used by sellers, or buyers, or by both sellers and buyers.

Definite-use electronic bank account payment phase from a buyer's perspective:
1-B. The buyer, who is the originator of the payment, provides an authorization to pay the seller.
2-B. The operator transmits the payment transaction from the buyer's definite-use electronic bank account to the seller's bank by the settlement date.
3-B. The operator transfer s money from the buyer's definite-use electronic bank account on the settlement date and confirms the transaction completion.
4-B. The Gateway automatically routes the payment information and status to the buyer.
   Definite-use electronic bank account payment phase from a seller's perspective:
1-S. The operator deposits the payment to the seller's definite-use electronic bank account on the settlement date.
2-S. The funds are moved from the seller's definite-use electronic bank account to the seller's main “parent” account.
3-S. Seller's bank confirms the transaction completion.
4-S. The Gateway automatically routes the payment information status to the seller.

### Closure Phase

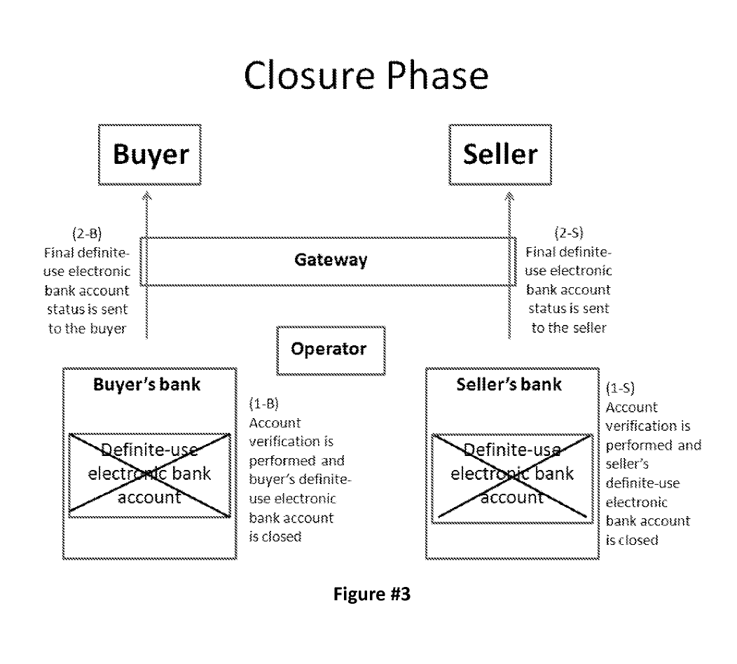

FIG. 3 shows the electronic payment system during the closure phase. The FIG. 3 shows the closure phase flow from both buyers' and seller's perspective; however, as already noted, the definite-use electronic bank account method does not require that it is implemented by both parties. It can be implemented and used by sellers, or buyers, or by both sellers and buyers.

Definite-use electronic bank account closure phase from a buyer's perspective:
1-B. The buyer's definite-use electronic bank account balance verification is performed to confirm that the authorized amount of funds from the definite-use electronic bank account was transmitted, and then the buyer's definite-use electronic bank account is closed. If a balance is detected, than the remaining funds are moved back to the buyers' main “parent” bank account, the buyer is notified, and the definite-use electronic bank account is closed.
2-B. The Gateway automatically routes the definite-use electronic bank account closure status to the buyer.

Definite-use electronic bank account closure phase from a seller's perspective:
1-S. The seller's definite-use electronic bank account balance verification is performed to confirm that all funds from the definite-use electronic bank account were moved to the seller's main bank account, and then the seller's definite-use electronic bank account is closed.
2-S. The Gateway automatically routes the definite-use electronic bank account closure status to the seller.
   The “definite-use electronic bank account” method enables an introduction of an innovative “e-Lock” feature. The definite-use electronic bank account funds are “good funds” because these funds have to be in the buyer's account for a “definite-use electronic bank account” to be established. The breakthrough e-Lock feature provides e-guarantee to the seller that the buyer has sufficient funds available and allocated “locked” to pay for goods and services. The funds protected by the e-Lock feature will be electronically locked and marked as allocated for the specific transaction. The e-Lock can be set up as a revocable or an irrevocable electronic account lock. The e-Lock is a key e-payment assurance feature for sellers. From the buyer's perspective, funds protected by the e-Lock may still continue earn interest until the actual e-payment transaction takes place.

The present invention is not to be limited in scope by the specific embodiments described herein.

Although the invention is described herein with reference to the preferred embodiment, one skilled in the art will readily appreciate that other applications may be substituted for those set forth herein without departing from the spirit and scope of the present invention. Indeed, various modifications of the present invention, in addition to those described herein, will be apparent to those of skill in the art from the foregoing description and accompanying drawings. Thus, such modifications are intended to fall within the scope of the appended claims. Furthermore, processes described in conjunction with Figures are intended as representative and not limiting, as they may be implemented in additional ways and using different terminology, all within the scope of the present invention.

The invention claimed is:

1. A method for conducting secure electronic financial transactions, comprising the following steps: During the initiation phase, issuing a definite-use electronic bank account that is used for a specific financial transaction, specific payment amount only, and electronic payment guarantee. Using the definite-use electronic bank account to conduct the authorized financial transaction during the payment phase. Using the definite-use electronic bank account to close the financial transaction during the closure phase.

2. A method as recited in claim 1, wherein the issuing steps comprise issuing a randomly generated number for each definite-use electronic bank account.

3. A method as recited in claim 1, wherein the definite-use electronic bank account maintains a parent-child relationship with a customer's main bank account.

4. A method as recited in claim 3, wherein the parent-child relationship is a hierarchical relationship, meaning that the definite-use electronic bank account is created and funded using the customer's main bank account, and upon the termination of the definite-use electronic bank account, all the remaining monies are deposited back to the customer's main account.

5. A method as recited in claim 1, wherein each definite-use electronic bank account is created for a specific transaction, definite obligation, and/or specific payment amount only.

6. A method as recited in claim 1, wherein during the initiation phase, the funds required for the financial transaction are allocated to the definite-use electronic bank account from the main “parent” bank account.

7. A method as recited in claim 1, wherein during the initiation phase, a confirmation containing the definite-use electronic bank account number, creation date, balance, and other pertinent information is sent to the main bank account holder(s) or authorized person(s).

8. A method as recited in claim 1, wherein during the payment phase, once the payment is authorized by the buyer, the funds are electronically transmitted from the buyer's definite-use electronic bank account to the seller's bank account, which could also be set up as a definite-use electronic bank account or could be just a “regular” bank account.

9. A method as recited in claim 1, wherein during the payment phase, once the payment is authorized by the buyer, the funds are electronically transmitted from the buyer's regular bank account to the seller's definite-use electronic bank account. This is in the case when only the seller is using the definite-use electronic bank account method.

10. A method as recited in claim 1, wherein during the closure phase, all the remaining monies in the buyer's definite-use electronic bank account are deposited back to the buyer's main bank account, and the buyer's definite-use electronic bank account is terminated.

11. A method as recited in claim 1, wherein during the closure phase, all the remaining monies in the seller's definite-use electronic bank are deposited to the seller's main bank account, and the seller's definite-use electronic bank account is terminated.

12. A method as recited in claim 1, wherein during the closure phase, after the money had been moved to the main bank account, the definite-use electronic bank account is terminated and closed.

13. A method as recited in claim 1, wherein during the closure phase, after the definite-use electronic bank account is terminated, the definite-use electronic bank account number is closed.

14. A method as recited in claim 1, wherein providing an electronic payment guarantee feature “electronic-Lock” (e-Lock hereafter), the e-Lock feature provides the electronic payment guarantee the seller that the buyer has funds available, allocated, and locked in the definite-use electronic bank account in order to be able to pay for goods and services.

15. A method as recited in claim 15, wherein the electronic payment guarantee provides payment assurance to the seller.

16. A method as recited in claim 15, wherein the funds protected by the electronic payment guarantee will be electronically secured “locked” in the definite-use electronic bank account and marked as allocated for a specific transaction.

17. A method as recited in claim 1, wherein the definite-use electronic bank account method does not require to be implemented by both parties, and it can be implemented and used by a seller, or a buyer, or by both the seller and the buyer.

18. A method as recited in claim 1, wherein the usage of the definite-use account method for a payment transaction eliminates the need to share the main bank account information or other sensitive financial data between buyers and sellers.

19. A method as recited in claim 1, wherein definite-use accounts are treated the same way as “normal” bank accounts from the external usage perspective.
